(19) United States
(12) Patent Application Publication
(10) Pub. No.: US 2010/0312492 A1
(43) Pub. Date: Dec. 9, 2010

(54) METHOD FOR DETERMINING THE STATE OF A ROAD SURFACE AND METHOD OF GENERATING A LOG OVER THE USE OF A VEHICLE

(75) Inventors: Per-Olov Fryk, Vastra Frolunda (SE); Fredrik Öijer, Goteborg (SE)

Correspondence Address: WRB-IP LLP, 801 N. Pitt Street, Suite 123, ALEXANDRIA, VA, 22314, US

(73) Assignee: VOLVO LASTVAGNAR AB, Goteborg (SE)

(21) Appl. No.: 12/518,048

(22) PCT Filed: Dec. 4, 2007
(86) PCT No.: PCT/SE2007/001082

§ 371 Date: Jun. 5, 2009

(30) Foreign Application Priority Data
Dec. 5, 2006 (SE) 0602606-6

(51) Int. Cl. G06F 15/00; G01M 19/00

(52) U.S. Cl. 702/33; 73/146

(57) ABSTRACT

A method for determining the state of a road surface on which a vehicle has traveled includes the steps of: a) retrieving a signal representative of the distance between the wheel axle and the vehicle body; b) providing, from the retrieved signal, a band pass filtered first component; c) calculating a first value representative of an excitation degree of the first component.

### BACKGROUND AND SUMMARY

The invention relates to a method for determining the state of the road surface on which a vehicle has traveled. The invention furthermore relates to a method of generating a log over the use of a vehicle, wherein the state of a road is classified into a number of severity classes

The state of a road surface may be determined by analysis of the spectra of vibrations occurring when the vehicle is run on the road surface. With the state of a road surface is hereby intended the quality, or degree of smoothness of a road surface. A synonym term used in literature is road severity. Uneven road surfaces will result in vibrations being transmitted through the wheels and suspension to the suspended mass of the vehicle including the vehicle frame, chassis and cabin etcetera. According to related art technology, the state of road surfaces can in general be described as combinations of random noise and discrete transient obstacles. Filtering technologies can be used to separate the random noise from the transient components. The random and transient parts may then be separately evaluated. Such related art technology requires large data processing capacity. Hence, there is a need for less complicated methods for determining the state of a road surface on which a vehicle has traveled.

In EP556070, a simplified method for determining a road condition is discussed. The method disclosed includes a step of continuously measuring the relative movement between the wheel and the vehicle body by use of a linear stroke sensor while a motor vehicle is running; a step of creating spectral distribution by subjecting the output of the linear stroke sensor to the frequency analysis; a step of calculating characteristic values inherent to various types of road conditions; and a step of specifying the type of the road condition based on the calculated characteristic values. When the type of the road condition is specified, the control device of this invention changes the damping force of the suspension to a level corresponding to the type of the road condition. The system according to EP556070 determines a road condition in the following manner: A relative movement between the wheel and vehicle body is continuously measured generating an input signal. An FFT transform of the input signal is generated providing a spectral distribution. Spectral values are combined and compared with threshold values. Depending on the result of the comparison with threshold values, the presence of a particular road condition is determined. In the patent document, the particular road condition is referred to as road surface state. The road surface state is separated into different classes, such as swell road, undulatory road, bad feeling road and bad road. It must here be noted that the input signal analysed is constituted by the measured distance between the wheel and vehicle body. The movement of the vehicle body relative to the wheel is dependent of the energy transmitted from the road over the suspension to the sprung mass. The energy transmitted to the sprung mass is dependent on the velocity of the vehicle as well as the state of the road surface. With the method and arrangement disclosed in EP 556070 it is not possible to separate the case where a vehicle is run at slow speed on a road having a relatively uneven surface, from the case where a vehicle is run at high speed on a road having a relatively smooth surface. Since the disclosed method is used for changing the damping force in dependence of the road condition, the actual state of the road surface is not of interest. What is of interest is the magnitude of vibrations which the vehicle is exposed to and which propagates through the wheel suspension. Hence, in the system described in EP556070 it is not necessary to separate whether the vehicle is run on a relatively smooth road at high speed or a relatively uneven road at slow speed, both resulting in similar magnitudes of vibrations, since an adequate setting of the dampers will be the same in both cases. A further disadvantage of systems operating according to the principle disclosed in EP556070 is that it requires a fast fourier transform, which demands large processor capacity. Since the system is used for controlling the suspension system a very frequent updating, probably at intervals less than 1 second, of the road condition, is necessary for operation of the system. This also implies large requirements on processor capacity, in addition to the large capacity required for performing the FFT operation.

Knowledge of the state of the road surface on which a vehicle has traveled is however beneficial for other purposes than setting the damping forces of a wheel suspension in a vehicle. Knowledge of the actual state of the roads on which a vehicle has traveled may be used to optimise maintenance programs for vehicle components, for determining suitable dimensioning criteria for vehicle components for a particular client, for ride comfort estimation etcetera.

U.S. Pat. No. 4,422,322 A discloses a method for determining the state of a road surface on which a vehicle is traveling. The distance between a mass of the vehicle and the road surface is measured by a sensor. The surface profile of the road is determined as a function of the measured value and the velocity of the vehicle. The value is filtered with a high pass filter in order to attenuate low frequency excitations and noise.

It is desirable to provide a method for determining the state of a road surface on which a vehicle has traveled, which method may separate the two scenarios from each other, that is a method which may determine the state of the road surface such that the case where a vehicle has traveled with high speed on an even surface can be separated from the case where a vehicle has traveled with low speed on a rough surface.

According to an aspect of the invention, the state of a road surface on which a vehicle has traveled is determined according to a method comprising the steps of:

a) retrieving a signal (S) representative of the distance (D) between the wheel axle (12) and the vehicle body (14);

b) providing, from said retrieved signal (S), a filtered first component (S1);

c) calculating a first value (V1) representative of an excitation degree of the first component (S1);

d) retrieving a signal representative of the velocity (v) of the vehicle;

e) compensating said first value (V1) for the influence of the velocity such that a first velocity compensated value (V1com, v) is generated;

f) comparing said first velocity compensated value (V1com, V) with stored data for classifying the state of the road on which the vehicle has traveled.

Since the first value is compensated for the influence of the velocity, which is substantial and essentially increases with the velocity v as v^{x}, where x is around 1.5, it is possible to establish the state of the road surface on which the vehicle has traveled, and not only how the combined effect of the state of the road surface and the velocity affects the movement of the sprung mass, as is the case with the prior art arrangement disclosed in EP 556070.

### BRIEF DESCRIPTION OF DRAWINGS

The invention will be described in further detail below, with references to appended drawings where:

FIG. 1 shows a flow scheme for a method for determining the state of a road surface on which a vehicle has traveled,

FIG. 2 shows a schematic side view of a vehicle including suitable means for performing the method according to the invention,

FIG. 3 shows a diagram that may be used in connection with determining the state of the road surface, and

FIG. 4 shows a matrix suitable for logging the use of the vehicle.

### DETAILED DESCRIPTION

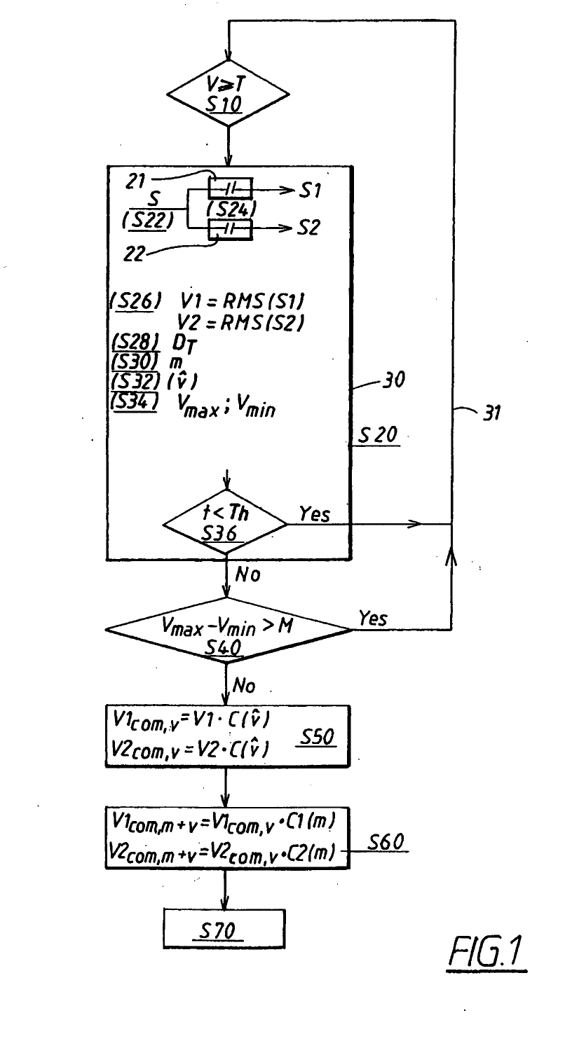

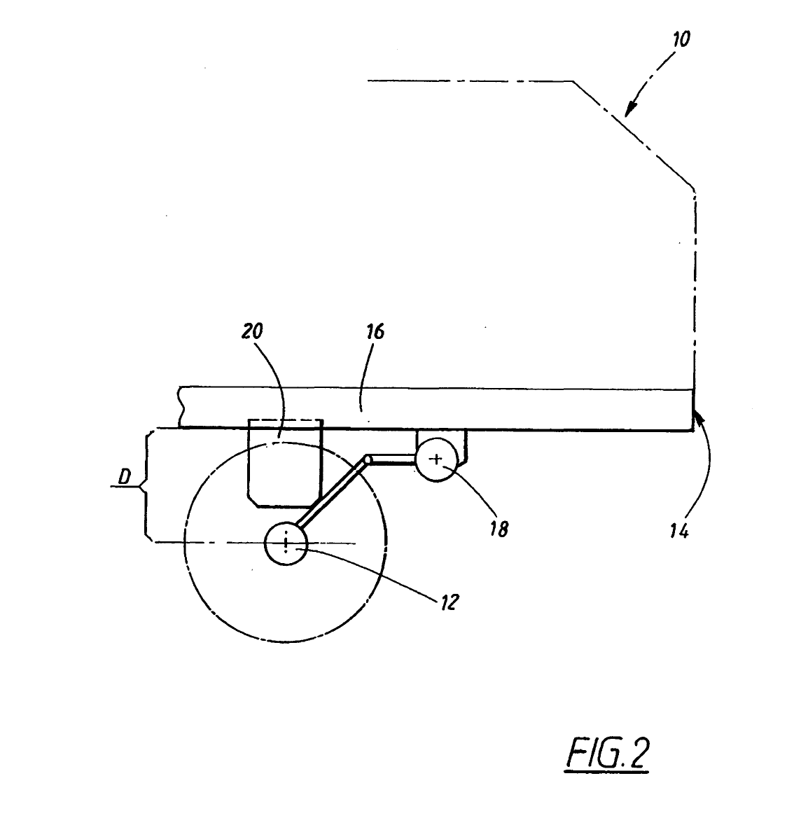

In FIG. 1 a flow scheme for a method for determining the state of a road surface on which a vehicle has traveled is shown. The state of a road surface is of fundamental importance for the vibration environment of the vehicle. A smooth road having few irregularities in the surface results in less vibrations than a road having large irregularities, or even holes or bumps in the road surface. The state of the road, in this application, relates to the degree of smoothness of the road surface. In FIG. 2 a schematic side view of a vehicle 10, which includes suitable means for performing the method according to the invention, is shown. The invention will initially be described with references to FIGS. 1 and 2.

In a first method step, S10, it is determined that the velocity v of the vehicle 10 exceeds a threshold value T. The threshold value T may be selected to be suitable for setting a lower limit of a velocity range where it is desirable to generate a log of the use of the vehicle. When a vehicle is driven at a very low speed, that is below the selected threshold value T, the result of the determination of the state of the road may become uncertain, due to the fact that the road surface characteristic may essentially be expressed as a function of the variation in distance divided by a function of the velocity. When the velocity approaches zero, the determination of the state of the road may become unstable. For velocities under the threshold value, torsion of the frame may be used to classify the state of the road where large torsions would indicate a bad road surface and small torsions would indicate a smooth road surface. In order to measure the frame torsion, a level sensor may be installed on each side of the vehicle. The threshold value T may suitably be selected to 10 km/h.

A second method step S20 is performed under a measurement window 30. The second method step S20 includes a set of substeps S22-S36 which are further explained below. The measurement window 30 may be set to a predefined time period. As a suitable time period 1 minute may be selected. In stead of a predefined time period also a specified travel distance or a calculated travel distance being dependent on an average velocity of the vehicle may be selected as defining the measurement window 30.

In the measurement window 30, the following operations are performed during the second method step S20: In a first substep S22 a signal S representative of the distance D between a wheel axle 12 and a vehicle body 14 is retrieved. Suitably the distance between the wheel axle 12 and a frame component 16 is measured. The measure of any distance between a suspended component, such as the vehicle frame 16, and an unsuspended component such as the wheel axle 12 may be selected as the input signal. Suitably a level sensor 18 for an air suspension 20 may be selected to generate the signal S representative of the distance D between a wheel axle 12 and a vehicle body 14. In a second substep S24 a first component S1 is provided by filtering said signal S. Preferably the first component S1 is representative of an axle resonance of a wheel axle 12 of the vehicle 1. In a preferred embodiment also a second component S2 representative of sprung mass motion in the vertical direction of the vehicle 10 is provided from said retrieved signal S. Generally with sprung mass motion is intended the rigid body motion of the vehicle body arranged above the wheel suspension, typically the motion of the vehicle frame in relation to the wheel or wheel axle. The first component representative of an axle resonance of a wheel axle 12 of the vehicle 10 is typically around 9-12 Hz for a heavy commercial vehicle. The second component S2 representative of the sprung mass motion corresponds to a measure of the energy content at a frequency band near the resonance frequency for the sprung mass of the vehicle, which is typically around 1-2 Hz for a heavy commercial vehicle. The second substep S24 may preferably include the steps of exposing the signal S to a first band pass filter 21 with a first frequency band around said axle resonance of a wheel axle of the vehicle in order to obtain said first component S1, and exposing said signal to a second band pass filter 22 with a second frequency band around sprung mass motion in the vertical direction of the vehicle in order to obtain said second component S2. The first band pass filter may suitable be selected to have a first frequency band between 5-15 Hz, preferably between 9-12 Hz, for heavy commercial vehicles. The second band pass filter may suitable be selected to have a second frequency band between 0.5-5 Hz, preferably between 1-2 Hz for heavy commercial vehicles.

In a third substep S26 a first value V1 representative of an excitation degree of the first component and a second value V2 representative of an excitation degree of the second component is calculated. The first and second values V1, V2 may suitably be calculated as the root mean square values (RMS values) of the first and second components S1 and S2 during the measurement window 30. Other measures such as a RMS value formed on a two times differentiated first and second component, which values would relate to an acceleration in stead of the position; level crossing or range spectra of the first and second component; addition of endpeaks; etc may suitably be selected as values representative of the excitation degree of the first and second component. In order to obtain a sufficient accuracy of the first and second component samples of the first and second component are provided at a sampling rate exceeding 10 Hz, preferably in the region of 40 Hz. In a fourth substep S28, the distance traveled DT under the measurement window is calculated. In a fifth substep S30, the suspended axle load is estimated. Suitably the estimation is performed by logging the drive axle pressure. In a sixth substep S32, the average velocity v under the measurement window is formed. In a seventh substep S34 the maximum and minimum velocities during the measurement window are estimated. A suitable sampling rate for the determining the maximum and minimum velocities is around 1 Hz. The traveled distance DT, the average velocity, and the drive axle pressure may suitable be determined only once during the measurement window 30. In an eight substep S36 it is determined whether the measurement window 30 has come to an end or not, by verifying whether the time t since start of the measurement window 30 is less than a threshold value Th. Alternatively, the eight substep S36, may be constituted by verifying whether the traveled distance Dτ has exceeded a threshold value. If the measurement window 30 has not come to an end, the operations under the first through the eight substeps are recommenced by returning in a feed back loop 31.

In a third optional method step S40, it is determined whether the difference between the maximum velocity vmax and the minimum velocity vmin is smaller than a threshold value M. The threshold value M may suitably be selected as the maximum of 10 km/h or vmax/5. The third method step S40 ensures that accurate estimations of the first and second component can be made. Large accelerations and decelerations give rise to vibrations which result in measurement noise.

In a fourth method step S50 the first and second values are compensated for the influence of the velocity, such that a first velocity compensated value V1com, v and a second velocity compensated value V2com, v are generated. The first and second velocity compensated values are preferably formed by multiplying the first and second values V1, V2 with a coefficient C dependent on the velocity of the vehicle in the measurement window. The average velocity under the window may be used. The coefficient C preferable increases with the velocity v as v^{x}, where x is selected between 1 and 2, preferably between 1.3 and 1.6, more preferably around 1.5. Values of the coefficient may be calculated or retrieved from a look up table.

In an optional fifth method step S60 the first and second values may be compensated for the influence of the suspended axle load, such that a first mass and velocity compensated value V1∞mim+V and a second mass and velocity compensated value V2com,m+v are generated. The first and second mass and velocity compensated values are preferably formed by multiplying the first and second velocity compensated values V1com, v, V2com, v with a coefficient C1 dependent on the suspended axle load in the measurement window. The drive axle pressure may be used as an input signal relating to the suspended axle load. The coefficient C1 increases with the mass, but at a much slower rate than dependency on the velocity of the coefficient C. The coefficient C1 is individual for each specific type of vehicle. Values of the coefficient may be calculated or retrieved from a look up table, which is generated through measurements on a road with a road surface having a known state, by varying the suspended axle load. The coefficient for mass compensation may be different for the first and second values respectively.

Naturally, values V1com, m+v, V2com, m+v, that are compensated for both the mass and the velocity may preferably be calculated in order to determine the state of the road on which the vehicle has traveled. For certain vehicles, the weight of the vehicle do not vary sufficiently in order to make it desirable to include the function of compensating for the weight, particularly since the coefficient C1 increases with the mass, but at a much slower rate than the coefficients Cs dependency on the velocity.

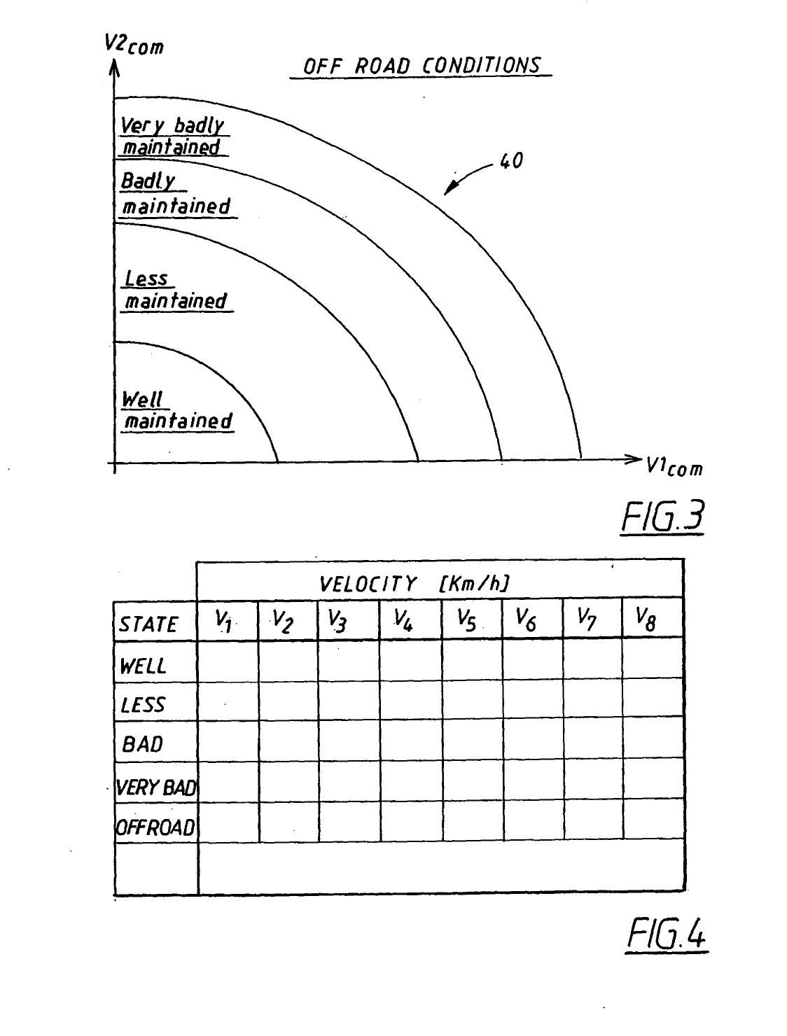

In a sixth method step S70, the first compensated value and second compensated value (V1com, V2com), that is either the velocity compensated values (V1com, v, V2com, v) or the mass and velocity compensated values (V1com,m+v, V2com,m+v) dependent on which embodiment is implemented, are compared with stored data for classifying the state of the road on which the vehicle has traveled. The compensated values (V1com, V2com) may thus be the velocity compensated value or the velocity and mass compensated values. The sixth method step may preferably include the step of locating the first and second compensated values (V1com, V2com) in a two dimensional diagram, and that the state of the road is classified by reference values applicable to the location of the first and second compensated values in the two dimensional diagram. An example of a diagram suitable for determination of the state of the road surface is given in FIG. 3. Instead of locating the first and second value in a diagram, a comparison of a function F dependent of the first and second compensated values (V1com, V2com), that is F=(F(V1com, V2com), with threshold values may be used, where F is an experimentally determined function.

When the state of the road has been determined, the information may be used in a method of generating a log over the use of a vehicle, wherein the state of a road is classified into a number of severity classes (well maintained, less maintained, badly maintained, very badly maintained and off road conditions), and the velocity of the vehicle is divided into a subset of velocities such that a two dimensional matrix is obtained. The distance driven at a particular velocity and a particular state of the road, determined by a method according to any of the claims is logged in a two dimensional matrix. An example of such a diagram is shown in FIG. 4. Of particular interest concerning wear of the vehicle is the distance driven on very badly maintained roads, and the distance driven on off road conditions. It may also be suitable to keep a separate column for the number of large bumps generating an energy input exceeding a certain level, since such bumps are critical to the wear of the vehicle. A further dimension constituting the suspended axle load may be added, whereby the suspended axle load is divided into a set of suitable ranges such that a three dimensional matrix is obtained; the distance driven at a particular velocity, with a particular suspended axle load and a particular state of the road, may be logged in the three dimensional matrix.

1. A method for determining the state of a road surface on which a vehicle has traveled, providing a filtered first component from a retrieved signal, characterized by the steps of
a) retrieving the signal representative of the distance between a wheel axle and the vehicle body;
b) providing, from the retrieved signal, the filtered first component, wherein the first component is representative of an axle resonance of a wheel axle of the vehicle, and exposing the signal to a first band pass filter with a first frequency band around the axle resonance of the wheel axle in order to obtain the first component;
c) calculating a first value representative of an excitation degree of the first component;
d) retrieving a signal representative of the velocity of the vehicle;
e) compensating the first velocity for the influence of the velocity such that a first velocity compensated value
is generated;
f) comparing the first velocity compensated value with stored data for classifying the state of the road on which the vehicle has traveled.

2. A method according to claim 1, wherein the first frequency band is between 5 and 15 Hz.

3. A method according to claim 1, wherein the step c) includes the step of forming a root mean square value of the first component in a measurement window in order to generate the first value.

4. A method according to claim 1, wherein the step e) includes the step of multiplying the first value with a coefficient dependent on the velocity of the vehicle.

5. A method according to claim 4, wherein the coefficient increases with the velocity v as v^{1.5}.

6. A method according to claim 1, wherein the step e) furthermore includes the step of compensating for the suspended axle load, by multiplying the first velocity compensated value with a first factor dependent on the suspended axle load in order to obtain a first velocity and mass compensated value.

7. A method according to claim 6, wherein the step f) is replaced with the step of comparing the first velocity and mass compensated value with stored data for classifying the state of the road on which the vehicle has traveled.

8. A method according to claim 1 wherein the method step b) includes the step b2) of providing a filtered second component from the retrieved signal and that the following further method steps are performed:
c2) calculating a second value representative of an excitation degree of the second component (82);
e2) compensating the second value for the influence of the velocity such that a second velocity compensated value is generated;
f2) comparing the second velocity compensated value with stored data for classifying the state of the road on which the vehicle has traveled.

9. A method according to claim 8, wherein the second component (82) is representative of sprung mass motion in the vertical direction of the vehicle.

10. A method according to claim 8, wherein the step b2 includes the step of exposing the signal to a second band pass filter with a second frequency band around the sprung mass motion in the vertical direction of the vehicle in order to obtain the second component.

11. A method according to claim 10, wherein the second frequency band is between 0.5-5 Hz.

12. A method according to claim 8, wherein the step c) further includes the step of forming a root mean square value of the second component in a measurement window in order to generate the second value.

13. A method according to claim 8, wherein the step e) further includes the step of multiplying the second value with a coefficient dependent on the velocity of the vehicle.

14. A method according to claim 13, wherein the coefficient increases with the velocity v as v^{1.5}.

15. A method according to claim 8, wherein the step e) furthermore includes the step of compensating for the suspended axle load by multiplying the second velocity compensated value with a second factor dependent on the suspended axle load in order to obtain a second velocity and mass compensated value.

16. A method according to claim 17, wherein the step f) is replaced with the step of comparing the first velocity and mass compensated value and the step f2) is replaced with the step of comparing the second velocity and mass compensated value with stored data for classifying the state of the road on which the vehicle has traveled.

17. A method according to claim 8 wherein the step f) includes the step of locating the first and second compensated values in a two dimensional diagram, and that the state of the road is classified by reference values applicable to the location of the first and second compensated values in the two dimensional diagram.

18. A method according to claim 1, comprising selecting the distance between the vehicle frame and the wheel axle as the signal.

19. A method according to claim 1, comprising generating the signal representative of the distance by means of a level sensor for an air suspension.

20. A method of determining a wear of a vehicle by generating a log over the use of a vehicle, wherein the state of a road is classified into a number of severity classes, and the velocity of the vehicle is divided into a subset of velocities such that a two dimensional matrix is obtained; wherein the distance driven at a particular velocity and a particular state of the road, determined by a method for determining the state of a road surface on which a vehicle has traveled, providing a filtered first component from a retrieved signal, according to claim 1, is logged in the two dimensional matrix.

21. A method according to claim 20, wherein a further dimension constituting the suspended axle load is added, whereby the suspended axle load is divided into a set of suitable ranges such that a three dimensional matrix is obtained; wherein the distance driven at a particular velocity, with a particular suspended axle load and a particular state of the road, determined by the method for determining the state of a road surface on which a vehicle has traveled, providing a filtered first component from a retrieved signal, is logged in the three dimensional matrix.

22. (canceled)

23. (canceled)
